(19) United States
(12) Patent Application Publication
(10) Pub. No.: US 2008/0291116 A1
(43) Pub. Date: Nov. 27, 2008

(54) CELLULAR ANTENNAS AND COMMUNICATIONS METHODS

(75) Inventors: Quoc M. LE, Plano, TX (US); Harold Edmond Asbridge, JR., Rowlett, TX (US); Douglas Alan Gribben, Murphy, TX (US)

Correspondence Address: WELSH & KATZ - COMMSCOPE, INC., 120 S. RIVERSIDE PLAZA, 22ND FLOOR, CHICAGO, IL, 60606, US

(73) Assignee: Andrew Corporation, Westchester, IL (US)

(21) Appl. No.: 11/753,762

(22) Filed: May 25, 2007

(51) Int. Cl. H01Q 1/00

(52) U.S. Cl. 343/907

(57) ABSTRACT

An antenna includes a main controller for communicating with an external system, a plurality of peripheral devices and a number of sub-controllers. The peripheral devices are associated with sub-controllers. The main controller communicates with the peripheral devices over a hybrid communications bus, addressing both bus-addressable devices and serial addressable devices.

### FIELD OF THE INVENTION

The invention relates to antennas and to communications methods. In particular, but not exclusively, the invention relates to cellular antennas and to communications methods used in such antennas. The communications methods may be used for communication of control data or control of peripheral devices.

### BACKGROUND TO THE INVENTION

Cellular antennas are generally controlled by base station controllers. Each antenna may have an interface for receiving control signals from the base station controller and an antenna controller for receiving the control signals and controlling antenna actuators and the like in accordance with the control signals.

The antenna controller must be capable of controlling each antenna actuator. Furthermore, where sensors are used for monitoring antenna characteristics, the antenna controller must also be capable of communicating with each sensor.

This is problematic because, as antennas become more complex, several peripheral devices such as actuators and sensors are included in the antenna. These devices use a variety of communication protocols, and include modern devices and legacy devices. The antenna controller must be capable of controlling and/or communicating with all of these devices. This not only requires a more sophisticated controller, but also makes retrofitting a new peripheral device into an antenna difficult and time-consuming.

It is an object of the invention to provide improved communications and control systems within antennas. It is another object of the invention to provide a standard communications interface for peripheral devices. It is a further object of the invention to provide a plug and play system for peripheral devices.

### Exemplary Embodiments

There is provided an antenna including a main controller and peripheral devices. The peripheral devices are associated with sub-controllers. A data bus carries commands or data between the main controller and the sub-controllers. There is also provided a system having a communications bus for carrying signals between a master controller and peripheral devices.

In a first exemplary embodiment there is provided an antenna including:
a main controller configured to communicate commands or data between the antenna and a remote controller;
a plurality of peripheral devices configured to monitor an attribute of the antenna or control an actuator of the antenna;
wherein each peripheral device is associated with a sub-controller connected to the main controller by a common data bus which conveys commands or data between the main controller and the sub-controller.

In a second exemplary embodiment there is provided a system including:
two or more peripheral devices; and a master controller configured to communicate commands or data with the peripheral devices over a communications bus including one or more data lines and one or more address lines,
wherein the master controller is configured to:
communicate commands or data over the one or more data lines and to communicate address data over the one or more address lines when communicating commands or data with some of the peripheral devices; and
communicate commands or data and address data over data lines when communicating commands or data with others of the peripheral devices.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a cellular antenna according to one embodiment;

FIG. 2 shows a communications packet structure;

FIG. 3 is a table showing line functions in a communications bus;

FIG. 4 shows the antenna controller of the antenna of FIG. 1;

FIG. 5 shows a cellular antenna according to a second embodiment;

FIG. 6 shows a base station according to a further embodiment;

FIG. 7 shows a base station according to another embodiment;

FIG. 8 shows a base station according to yet another embodiment;

FIG. 9 shows a base station according to a further embodiment;

FIG. 10 shows a base station according to another embodiment; and

FIG. 11 shows a base station according to yet another embodiment.

### DESCRIPTION OF EMBODIMENTS OF THE INVENTION

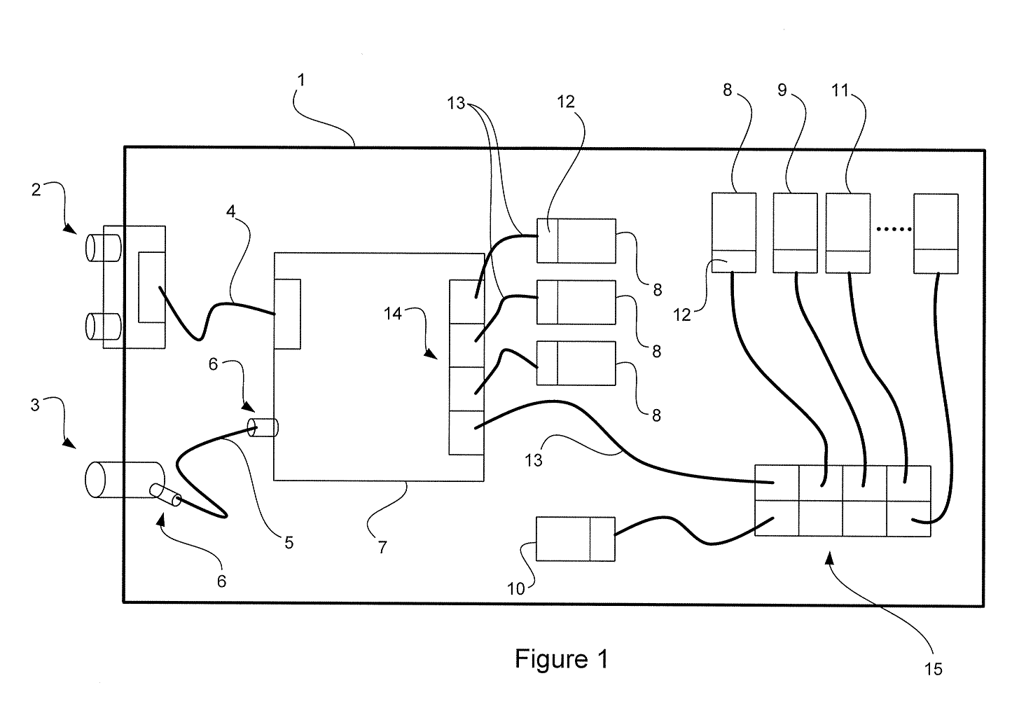

FIG. 1 shows a cellular antenna 1. The antenna 1 includes one or more interfaces 2, 3 for communication of signals to and from an external controller. The interface 2 may be an Antenna interface Standards Group (AISG) connector configured to connect an external AISG line (not shown) to an internal communications line 4 with RJ45 connections. A RF signal interface 3 may also be provided, connecting an external RF communications line to an internal communications line 5 (e.g. a RG-142 coaxial line), using an SMA connector 6. Power for the antenna may be provided by way of a bias T arrangement. Many different types of interface 2, 3 and communications line 4, 5 may be suitable. Also, the interface could be a wired or wireless interface, receiving signals from a wired communications line, over a wireless connection or optical connection.

FIG. 1 in general shows the control and sensing aspects of the antenna 1. The antenna also has a communications function, and so includes one or more antenna elements (not shown) for receiving and/or transmitting signals to wireless user devices.

Signals transmitted via the interface over the communications lines 4, 5 pass to a main or master controller 7. The main controller receives commands and other data from an external controller, transmits data to the external controller, transmits commands and other data to peripheral devices and receives data from peripheral devices, as described below.

The antenna may include one or more peripheral devices. These devices may include one or more antenna actuator motors or drivers 8 (including solenoid drivers), for adjustment of components such as phase shifters and mechanical components, for adjustment of antenna characteristics such as azimuth angle, downtilt angle and beam-forming characteristics (beam width, for example).

The peripheral devices may include one or more sensors. The sensors may include a GPS receiver 9, inclinometer 10, azimuth angle sensor 11, as well as position sensors, angle sensors, phase sensors, sun direction sensors (for determining antenna orientation) and any other sensors useful in antennas.

In general, the peripheral devices may include any bus-addressable devices or serial addressable devices.

The peripheral devices may be associated with sub-controllers 12. A sub-controller 12 may be part of a peripheral device or may be formed separately and connected to the peripheral device by any suitable connection. Each sub-controller 12 may include a processor and is adapted to communicate with the main controller. In particular, the sub-controllers are capable of interpreting control data and/or other data sent by the main controller.

Use of sub-controllers 12 allows a standard interface to be provided. Each sub-controller 12 is capable of communications with the main controller 7 over the communications bus described below. This means that peripheral devices (together with sub-controllers) can be added in a ‘plug and play’ manner, without any need for reconfiguring the main controller 7 to communicate with the new peripheral device.

The sub-controllers/peripheral devices may communicate with the main controller using a listen-first, talk-second protocol.

The sub-controllers 12 may communicate with the main controller over communications lines 13 having RJ45 connections. Four peripheral devices may be connected using a 1 by 4 RJ45 connector 14. Alternatively, a larger number of devices may be connected using a 2 by 8 RJ45 distribution hub 15, for example. The RJ45 components may be connected using Ethernet cable, such as CAT5E of CAT6 cable. Other connectors and hubs may be used to connect to a desired number of peripheral devices.

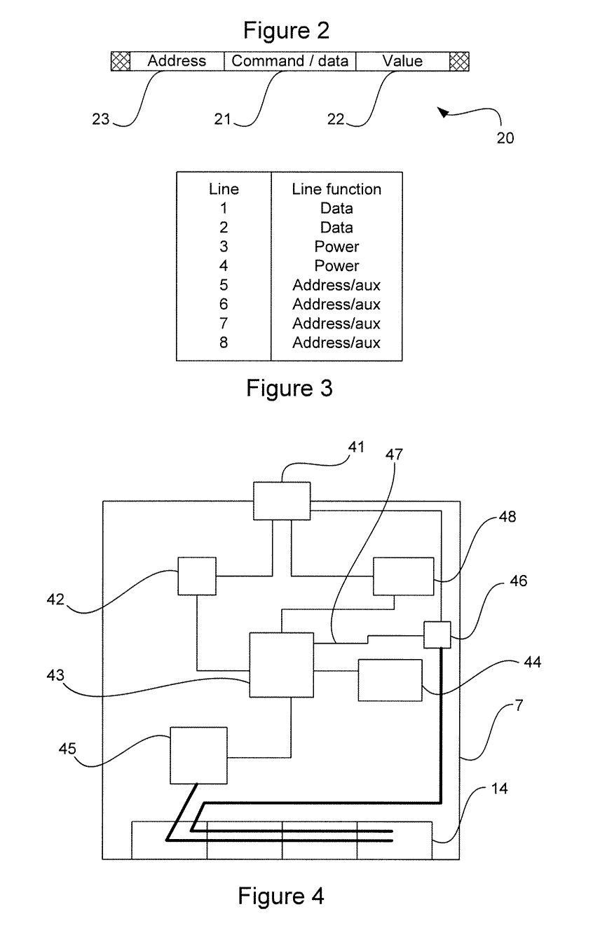

The peripheral devices may include devices which are serially addressable by means of address information in a data packet, as shown in FIG. 2. A data packet 20 includes command or other data 21 and a value 22 for validation or error detection purposes. Address data 23 may be included, usually in the packet header, and identifies a particular device or set of devices for which the data 21 is intended.

However, some devices may not be addressable in this way. A hybrid communications bus may be used to address both devices which may be addressed using address information in a data packet and devices which are bus-addressable using address line signals, as described below.

An RJ45 connector includes eight lines. In the hybrid communications bus (see FIG. 3) two differential data lines (lines 1 and 2) may be used for serial transmission of data. Two lines are used to provide power to the sub-controllers and peripheral devices (lines 3 and 4).

The four remaining lines (lines 5 to 8) may be used for addressing bus-addressable peripheral devices which cannot be addressed using address data in a data packet. Peripheral devices may be addressed using the address lines in any suitable manner. For example, the first bit (e.g. line 5) may select a bus-addressable mode and the three remaining lines (6 to 8) may select up to eight devices using the eight unique bit combinations 000 to 111.

When the address lines are not required for addressing (i.e. when the device can be addressed using address data in a data packet) they may be used for some auxiliary function.

One address line may be used as a ‘bus-addressable mode’. This address line then carries an on/off signal indicating whether or not the device addressed is a bus-addressable device. In this example when line 5 is low a packet-addressable mode may be selected. The remaining three lines may be used to address a particular bus-addressable device, or for some auxiliary function if a serial addressable device is to be addressed.

Where the address lines are to be used for an auxiliary function, auxiliary signals are communicated over those lines. The auxiliary functions/signals may include the ‘bus-addressable line’ described above; mode data, including peripheral function mode data, memory mode data, or peripheral type data; or peripheral device present signals or indicator signals.

The peripheral function mode data specifies a particular peripheral function, and the sub-controller switches the peripheral function based on the data. Functions may be integrated into a sub-controller ASIC, with the address lines being used to instruct the sub-controller and peripheral device to operate in a certain functional mode. For example, a peripheral device may consist of a multi-sensor module (e.g. having position, phase and inclination sensors). This module may be arranged to receive mode instructions over the address lines, with the mode instructions specifying a certain sensing function (position, phase or inclination). This allows a simplified software interface to be used.

The memory mode data specifies a particular memory range to be accessed by the sub-controller. For example, memory may be provided that is accessible to two or more sub-controllers. Each sub-controller is instructed to access the correct memory table in order to control a particular antenna function correctly. Alternatively, a single sub-controller could be instructed to access different memory tables depending on how a particular peripheral device is to controlled.

The peripheral type data specifies a particular peripheral device type. The peripheral device type could be ‘bus-addressable devices’. Alternatively, there could be a class of non-critical devices which could be switched off if power supply was interrupted or for power-saving. Then a ‘power-critical mode’ could be specified. Peripheral device type could also specify a group of devices using a particular messaging protocol.

The peripheral device present signals are sent from peripheral devices to the main controller to indicate their presence. Indicator signals may also be sent over the address lines. These instruct operation of indicators, such as visual indicators (e.g. LEDs) or audible indicators (e.g. buzzers, speakers etc). This allows feedback on antenna operation when the antenna is enclosed within its housing.

FIG. 4 shows a more detailed view of one realization of the main controller 7. The main controller includes an RJ45 connector 41 for communicating via a cable and AISG connector 2 (FIG. 1) with external systems. The connector 41 separates power supply (bias T) and data signals. Data signals pass through a transceiver 42 to a microcontroller 43. The microcontroller 43 may be a LPC2138 ARM microcontroller, for example. The microcontroller is configured to access memory 44.

Control instructions and other data may be sent to the microcontroller 43 from an external system. The microcontroller 43 then controls the functioning of the antenna in accordance with these signals. For example, the microcontroller 43 may send control or other data to a peripheral device. This data is sent through a transceiver 45 to the RJ45 four port connector 14, over the communications bus to the peripheral device (not shown in FIG. 4).

The power supply received by the RJF45 connector 41 as well as the ground connection are separated and sent to switch 46. The switch is controlled by the microcontroller 43 over control line 47 and supplies power and ground to the RJ45 four port connector 14. A storage device 48, such as a 3V battery, is also recharged by power received from outside the antenna and powers the microcontroller 43.

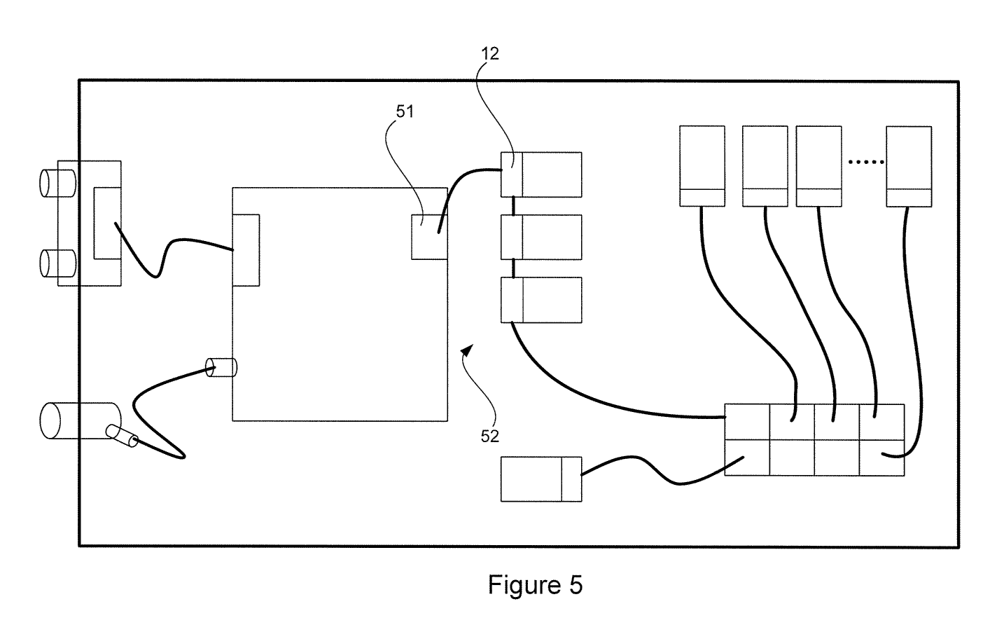

FIG. 5 shows an alternative configuration in which the main controller 7 includes a single RJ45 port 51 and the peripheral devices are connected to the communications bus in a daisy chain configuration 52. In this case each sub-controller 12 has two RJ45 connectors. This antenna is otherwise similar to that of FIG. 1.

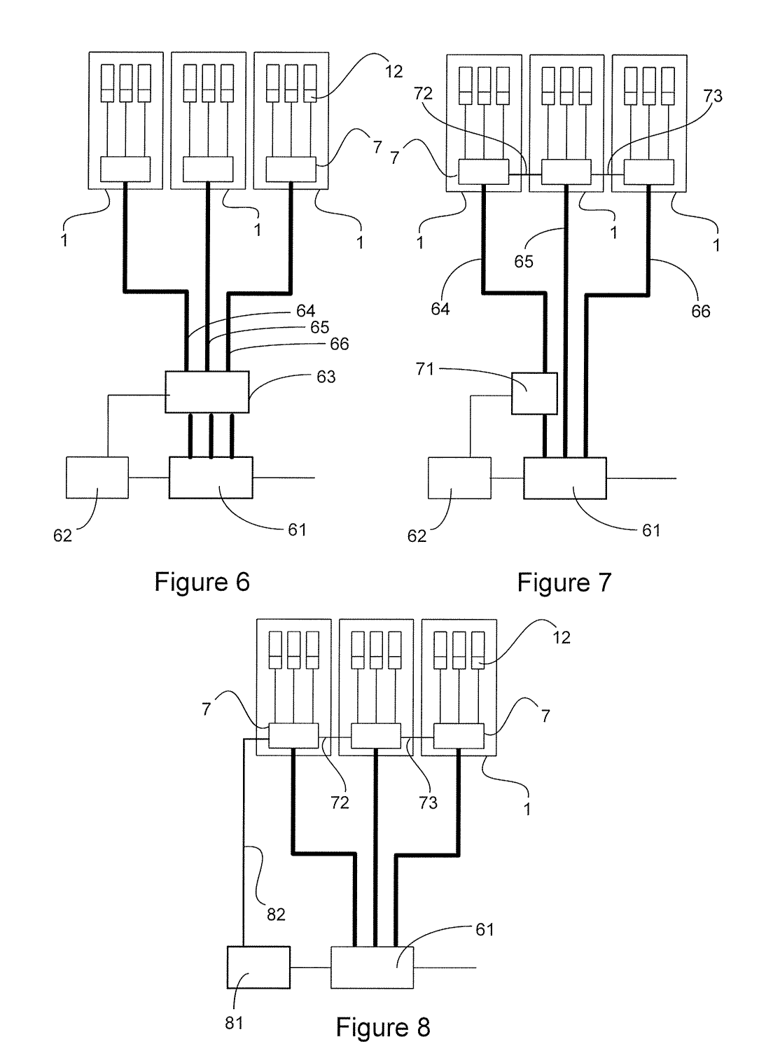

FIG. 6 is a schematic diagram of a base station including a number of antennas 1 such as those described above. The base station includes a base station controller 61 and an auxiliary equipment controller 62. The base station controller provides RF signals to an interface 63, while the auxiliary equipment controller 62 provides command signals or other data to the interface 63. The interface uses a modulation arrangement to overlay command and other data on the RF signals, so that both are sent to the appropriate antenna over a coaxial feed cable 64, 65, 66. Each antenna 1 is configured to separate the command and other data from the RF signals.

FIG. 7 shows an alternative base station arrangement. Command and other data is sent over only a first RF feed cable 64, using interface 71. The main controllers 7 of the antennas 1 may be connected in a daisy chain arrangement by ASIG compliant serial cables 72 and 73.

FIG. 8 shows a further alternative base station arrangement, in which the auxiliary equipment controller 81 communicates directly with the main controller 7 of one antenna. The other main controllers 7 are again connected by serial lines 72, 73 in a daisy chain arrangement.

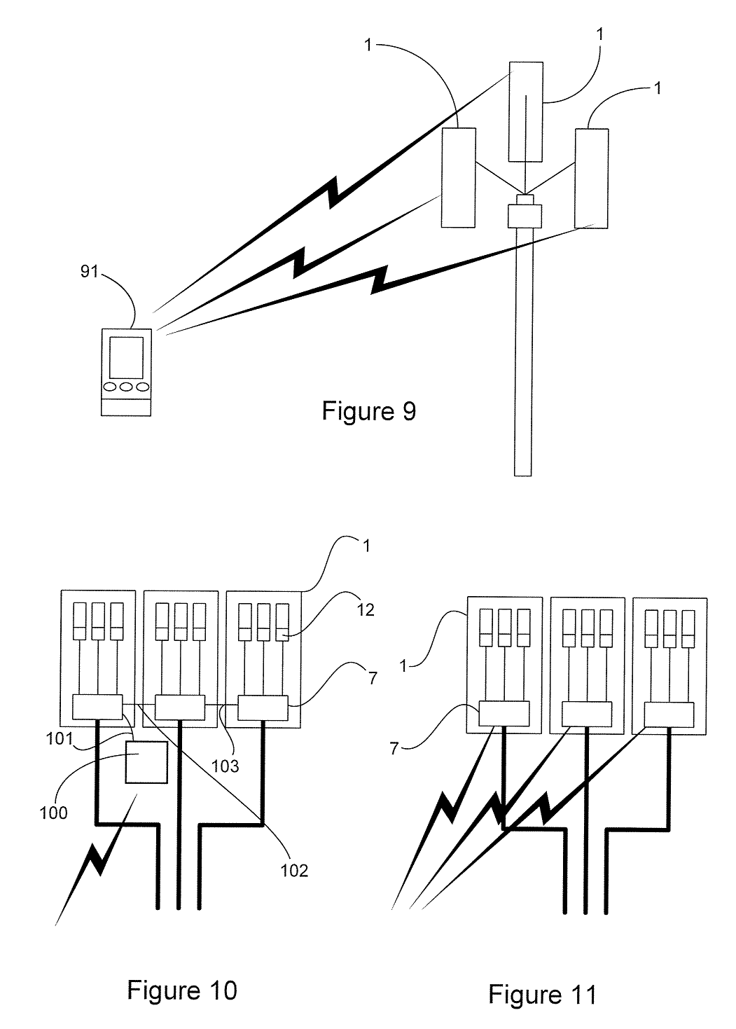

FIG. 9 shows another base station arrangement in which a wireless device 91, or a controller equipped with a wireless communications interface, communicates over a wireless link with the antennas 1. As shown in FIG. 10, the wireless device may communicate with a wireless receiver 100, which then communicates with the main controllers 7 of the antennas 1 using a serial ASIG compliant daisy chain arrangement 101, 102, 103. Alternatively, as shown in FIG. 11, the wireless device may communicate directly with each antenna 1. In this case each main controller 7 is configured to receive wireless signals, or is provided with a separate wireless receiver.

The systems and antennas described above are capable of controlling motorized actuation for electronic downtilt, azimuth panning and beam forming. They are also capable of operating sensors for detection of antenna position, orientation, phase values and the like. They provide ease of manufacturing, overall usage and installation of peripheral devices. They use cost-effective components such as RJ45 connectors and Ethernet cabling for interconnections and the data bus.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An antenna including:
i. a main controller configured to communicate commands or data between the antenna and a remote controller;
ii. a plurality of peripheral devices configured to monitor an attribute of the antenna or control an actuator of the antenna;
wherein each peripheral device is associated with a sub-controller connected to the main controller by a common data bus which conveys commands or data between the main controller and the sub-controller.

2. An antenna as claimed in claim 1 wherein the peripheral devices include one or more devices from the group consisting of: antenna actuators controlling azimuth angle, downtilt angle or beamwidth; GPS receivers; azimuth angle sensors; inclinometers; phase sensors; position sensors; phase shifters; mechanical drivers; motors; and solenoid drivers.

3. An antenna as claimed in claim 1 wherein the peripheral devices are bus-addressable or serial addressable objects or devices.

4. An antenna as claimed in claim 1 wherein the main controller is configured to communicate commands or data between the antenna and a remote controller over a wired, wireless or optical link.

5. An antenna as claimed in claim 1 wherein the data bus includes one or more data lines and one or more address lines, and the main controller is configured to:
a. communicate commands or data over the one or more data lines and to communicate address data over the one or more address lines when communicating commands or data with some of the sub-controllers; and
b. communicate commands or data and address data over data lines when communicating commands or data with others of the sub-controllers.

6. An antenna as claimed in claim 5 wherein the data bus includes two differential data lines, two power lines and four address lines.

7. An antenna as claimed in claim 6 wherein the data bus interfaces using RJ45 connectors.

8. An antenna as claimed in claim 5 wherein the main controller is configured to communicate commands or data and address data in packet form when communicating over the data lines, each packet including commands or data and address data.

9. An antenna as claimed in claim 5 wherein the main controller is configured to communicate auxiliary signals over the address lines, when commands or data and address data are communicated over the data lines.

10. An antenna as claimed in claim 9 wherein the auxiliary signals include a bus-addressable device signal indicating whether the peripheral device to be addressed is a bus-addressable device.

11. An antenna as claimed in claim 9 wherein the auxiliary signals include mode data specifying a peripheral device mode.

12. An antenna as claimed in claim 11 wherein the peripheral device mode is a member of the group consisting of: peripheral function mode, memory mode and peripheral type mode.

13. An antenna as claimed in claim 12 wherein the memory mode specifies memory to be accessed for control of the peripheral device.

14. An antenna as claimed in claim 12 wherein the peripheral type mode is from the group consisting of: power-level mode, power-critical mode and a protocol mode.

15. An antenna as claimed in claim 9 wherein the auxiliary signals include a peripheral device present signal.

16. An antenna as claimed in claim 9 wherein the auxiliary signals include indicator signals.

17. An antenna as claimed in claim 1 including an expansion hub for increasing the number of peripheral devices that can be connected to the data bus.

18. An antenna as claimed in claim 1 wherein the sub-controllers communicate with the master controller over the data bus using a listen-first, talk-second protocol.

19. An antenna as claimed in claim 1, the antenna being a cellular base station antenna.

20. A cellular base station including one or more antennas as claimed in claim 19 controlled by a common remote controller.

21. A system including:
i. two or more peripheral devices; and
ii. a master controller configured to communicate commands or data with the peripheral devices over a communications bus including one or more data lines and one or more address lines,
wherein the master controller is configured to:
a. communicate commands or data over the one or more data lines and to communicate address data over the one or more address lines when communicating commands or data with some of the peripheral devices; and
b. communicate commands or data and address data over data lines when communicating commands or data with others of the peripheral devices.

22. A system as claimed in claim 21, being part of a cellular antenna.

23. A system as claimed in claim 21 wherein the communications bus includes two differential data lines, two power lines and four address lines.

24. A system as claimed in claim 23 wherein the communications bus interfaces using RJ45 connectors.

25. An antenna as claimed in claim 21 wherein the master controller is configured to communicate commands or data and address data in packet form when communicating over the data lines, each packet including commands or data and address data.

26. An antenna as claimed in claim 21 wherein the master controller is configured to communicate auxiliary signals over the address lines, when commands or data and address data are communicated over the data lines.

27. A system as claimed in claim 26 wherein the auxiliary signals include a bus-addressable device signal indicating whether the peripheral device to be addressed is a bus-addressable device.

28. A system as claimed in claim 27 wherein the bus-addressable device signal is sent over one of the address lines.

29. A system as claimed in claim 26 wherein the auxiliary signals include mode data specifying a peripheral device mode.

30. A system as claimed in claim 29 wherein the peripheral device mode is a member of the group consisting of: peripheral function mode, memory mode and peripheral type mode.

31. A system as claimed in claim 30 wherein the memory mode specifies memory to be accessed for control of the peripheral device.

32. A system as claimed in claim 30 wherein the peripheral type mode is from the group consisting of: power-level mode, power-critical mode and a protocol mode.

33. A system as claimed in claim 26 wherein the auxiliary signals include a peripheral device present signal.

34. A system as claimed in claim 26 wherein the auxiliary signals include indicator signals.

35. A system as claimed in claim 21 including an expansion hub for increasing the number of peripheral devices that can be connected to the communications bus.

36. A system as claimed in claim 21 including one or more sub-controllers each associated with a peripheral device.

37. A system as claimed in claim 21 wherein the peripheral devices communicate with the master controller using a listen-first, talk-second protocol.

38. A system as claimed in claim 21 wherein the master controller is configured to receive command signals from an external system.
